(19) United States
(12) Patent Application Publication
(10) Pub. No.: US 2005/0108112 A1
(43) Pub. Date: May 19, 2005

(54) System and method for facilitating the real-time pricing, sale and appraisal of used vehicles

(76) Inventors: John Ellenson, Whitby (CA); Todd Bennett, Fenelon Falls (CA); Richard Goldman, Toronto (CA)

Correspondence Address: BERESKIN AND PARR, 40 KING STREET WEST, BOX 401, TORONTO, ON, M5H 3Y2, CA

(21) Appl. No.: 11/025,033

(22) Filed: Dec. 30, 2004

Related U.S. Application Data
(63) Continuation of application No. 10/126,532, filed on Apr. 22, 2002, now abandoned.

(51) Int. Cl. G06F 17/60

(52) U.S. Cl. 705/27

(57) ABSTRACT

The present invention relates to a system and method for facilitating the real-time pricing, sale, and appraisal of used vehicles. In an embodiment of the present invention, there is provided a computer-based system and method of collecting data supplied from buyers in constructing appraisal profiles, and for calculating, in real-time, a guaranteed price for a used vehicle having specific attributes as described by a seller based on the appraisal profiles. According to one aspect of the present invention, there is provided a method of facilitating the real-time pricing, sale, and appraisal of a used vehicle comprising the steps of receiving input data and generating at least one associated appraisal profile for each of a first plurality of buyers, where the input data associated with an appraisal profile comprises check writing prices for a plurality of used vehicle models, where each check writing price represents a price offered by the respective buyer to purchase a used vehicle of a used vehicle model to which a plurality of base conditions apply; receiving a request from a seller for a guaranteed price for a specific seller-identified used vehicle, where the used vehicle model and actual condition of the seller-identified used vehicle are described in the request; generating at least one guaranteed price for the seller-identified used vehicle from the at least one appraisal profile; and outputting the guaranteed prices to the seller.

This application is a continuation of application Ser. No. 10/126,532 filed on Apr. 22, 2002.

### FIELD OF THE INVENTION

The present invention relates to a system and method for facilitating the sale of vehicles, and is more particularly concerned with a computer-based system and method for pricing used vehicles for appraisal and sale.

### BACKGROUND OF THE INVENTION

As the prices of new vehicles (e.g. cars, vans, trucks, motorcycles, etc.) continue to rise, the consumer demand for used vehicles is increasing. Some consumers view the purchase of a used vehicle as a means of acquiring their vehicle of choice without having to incur the expenses associated with the purchase of a new vehicle. Purchasing used vehicles is also becoming a more attractive option as the quality of new vehicles improve; the downstream effect of improved new vehicle quality is that used vehicles typically stay on the road longer. Certification programs being offered by vehicle manufacturers also serve to alleviate consumers' fears of purchasing poor-quality used vehicles. These programs have also contributed to increased sales of used vehicles.

The supply of used vehicles has also increased dramatically in recent years due to the increased popularity of leasing as an alternative to purchasing new vehicles. When the leases expire on these vehicles, the vehicles typically add to the supply of used vehicles available for sale to consumers.

The pricing of used vehicles can be a considerably more complex task than the pricing of a new vehicle. While the condition of new vehicles (both its mechanical condition and its visual condition, for example) does not typically differ significantly from vehicle to vehicle, the condition of used vehicles often does. Different factors relating to the condition of a used vehicle are taken into account when pricing the vehicle, and each of these factors can have a significant effect on the ultimate price of the vehicle. Many prior art systems and pricing techniques that are used to price new vehicles assume that the vehicles are in “perfect” condition. These systems and techniques cannot be used to effectively or accurately price used vehicles since the condition of used vehicles often varies significantly from vehicle to vehicle.

Pricing and Selling Used Vehicles: the Consumer's Perspective

Historically, there have been primarily three common methods for a consumer to sell a used vehicle. One common method is to sell the used vehicle to a new vehicle dealer. This is typically done by way of a “trade-in” transaction in which the consumer sells his used vehicle to the new vehicle dealer for a negotiated amount. That amount is then subsequently deducted from the cost of a new vehicle being purchased or leased.

Another common method is to sell the used vehicle to a used vehicle dealer. The consumer can sell his used vehicle to the used vehicle dealer for cash, or for a discount that can be applied towards the purchase or lease of another used vehicle.

Alternatively, a consumer might sell the used vehicle in a private transaction with another consumer. A potential buyer might be found through “word-of-mouth” means, or commonly through classified advertisements placed in newspapers, in used vehicle magazines, or online, for example.

Unfortunately, these methods for selling vehicles can be time-consuming and inefficient. All of these methods typically require a certain amount of negotiation between the buyer and seller. From the consumer's point-of-view, it may be difficult to predict the ultimate sale price of the vehicle, or what it ought to be based on the current demand for the vehicle, since the consumer typically does not have access to the same information that a dealer will have access to for determining the fair market value of the vehicle. For example, the consumer may not be aware that his vehicle may be in extremely high demand in a particular month, and therefore might have an abnormally high market value that month. While the consumer might be able to more accurately assess the current market value of his vehicle by having it appraised at numerous vehicle dealers, the process of obtaining numerous quotes can be inconvenient and time-consuming.

The ultimate sale price may vary depending not only on the market demand for such vehicles, but also on the consumer's own ability to negotiate a sale price. Some consumers are not comfortable with having to negotiate a sale price for their vehicles, and may indeed be at a disadvantage if the potential buyer is a better negotiator. Consumers who choose not to negotiate at all often end up selling their vehicle at a sub-optimum value.

In summary, some consumers view the selling of their vehicles as pressure-filled situations, where they must make significant selling decisions with incomplete information.

There may also be disadvantages related specifically to the sale of vehicles in private (consumer-to-consumer) transactions. For example, potential purchasers may feel less willing to buy vehicles in private transactions for fear of fraud, quality problems, and inconveniences that must be endured when trying to find a buyer for the vehicle, or when performing tasks that must be carried out to complete the transaction (e.g. complying with regulatory requirements).

Recently, with the increasing popularity of the Internet, several online mechanisms for the sale and purchase of vehicles are also now available to consumers. Online auction web sites may be used by consumers to sell and purchase a wide variety of goods. For example, when a consumer wishes to sell an item, he can post a description of that item on the web site. Potential purchasers can bid for the item, allowing the consumer to sell the item to the highest bidder.

When a vehicle is to be sold through such online auction web sites, the transaction is typically consumer-to-consumer and not consumer-to-dealer. As a result, the disadvantages related to private consumer-to-consumer transactions also typically apply to online auction sales. Furthermore, because it may be particularly difficult to reach local buyers, high delivery costs and the difficulties and inconveniences which may arise when arranging for an inspection of the vehicle for sale may limit the use of online auction web sites by consumers.

Once a description for an item has been posted on the online auction web site, there is typically a period in which the consumer will wait before the item is sold, in order to increase the likelihood of obtaining a better price. The ultimate sale price will also depend on the number of potential buyers who have seen the posting and who have decided to place a bid on the item. Typically, the less potential buyers who have bid on the item, the less likely a fair market price has been offered for the item. Thus, online auction web sites may not be a viable alternative for consumers who do not wish to endure the delay associated with the sale of the item, particularly if there is no guarantee that their posting will attract a desirable number of bids.

Tools to facilitate the appraisal of used vehicles also exist in the prior art. For example, traditionally, the Black Book and Kelley Blue Book have been used by vehicle dealers and consumers to value used vehicles. These two publications are published periodically and provide estimated wholesale values on used vehicles based upon the year, make of the vehicle for sale, mileage, options, accessories, and other aspects relating to the vehicle's overall condition. While these books may be helpful in determining a value for the vehicle for sale, the value is merely an estimate and not a price that must be honored by any vehicle dealer. The values of vehicles supplied by these books are not continuously updated. Therefore, current demand (or lack thereof) of a specific vehicle at any given time are not reflected in these values. The values in the books also do not reflect the current demand (or lack thereof) of a specific vehicle in a particular geographical area.

A limited number of vehicle dealers offer online appraisals of vehicles through their own private vehicle dealer web sites. A consumer can enter details on the vehicle he wishes to sell on an HTML-based form. When the dealer receives the appraisal or pricing request, the dealer then considers the details received and provides the consumer with a quote for the vehicle. However, this quote may not accurately reflect the value that other vehicle dealers might offer for the same vehicle. The consumer cannot expect a different dealer to honor the quote, and quotes provided by one dealer are not provided to other dealers. The consumer typically must sell the vehicle to the dealer providing the quote in order to obtain that price even if, for other reasons, the consumer would prefer to sell the vehicle to a different dealer. This can also be a slow process if the dealer receiving the appraisal request does not respond to the consumer in a timely manner.

In order to better estimate the demand for a user's vehicle at a given time in a given geographical location, multiple appraisals are typically obtained. However, as with the process of obtaining separate “in-person” appraisals from multiple vehicle dealers, obtaining separate online appraisals can be equally, if not more time-consuming.

Pricing and Selling Used Vehicles: the Dealer's Perspective

While the consumer primarily sells or purchases used vehicles through new or used vehicle dealers, there exists an elaborate network of businesses and individuals that make the remarketing of millions of used vehicles in North America each year possible. Used vehicles make their way from various sources (e.g. dealers, factories, fleet operators, leasing organizations, consumers, etc.) to consumers through a variety of channels. Automobile auctions are typically the largest wholesale intermediary, and dealers are typically the largest source of auction vehicles. Vehicle manufacturers, fleet operators, financial institutions, captive finance subsidiaries and rental companies are other sources of auction vehicles. These vehicles are, in turn, often purchased by other vehicle dealers for resale to consumers. However, the purchase of used vehicles through the auction process can be a time-consuming process, and typically requires the purchasing dealers to predict, sometimes inaccurately, the future demand for the vehicles being auctioned at the time of the auction. As the consumer demand for used vehicles increases, vehicle dealers of used vehicles are seeking more efficient ways of meeting this demand.

Before a dealer obtains a used vehicle from a consumer (e.g. as a “trade-in” vehicle in a transaction being negotiated), the dealer is typically required to appraise the vehicle to aid in the calculation of an acceptable purchase price. Traditionally, as explained earlier, publications such as the Black Book and Kelley Blue Book have been used by vehicle dealers to value used vehicles. However, the values of vehicles supplied by these books are not continuously updated and may, in some cases, be considerably outdated.

Furthermore, the values of vehicles supplied by these books are merely an estimate of the current value of the vehicles. There is no guarantee that a used vehicle will be purchased by another consumer or another dealer at the estimated value. Not only does the value of a given vehicle depend on the demand for the specific type of vehicle at a given time, the demand for any given vehicle may differ across dealers serving different geographical areas or segments of the populations for example, which in turn is reflected in different valuations that may be placed on the vehicle by different dealers. As a further example, a specific dealer may have customers who have expressed an interest in buying a specific type of used vehicle that is not currently stocked by the dealer; that dealer, having already made contact with interested customers, would likely place a higher value on a used vehicle of the desired type than other dealers who are not in contact with any interested customers.

Accordingly, when a dealer is faced with the task of pricing or valuing a used vehicle being obtained from a consumer as a “trade-in” for example, there are only a limited number of ways of obtaining an accurate “real-time” valuation for the vehicle. If the dealer does not wish to stock the used vehicle in his own dealership, the dealer may want to explore the possibility of reselling the vehicle to a different dealer or wholesaler. The dealer may phone other dealers or wholesalers to determine the vehicle's resale value. However, this is a time-consuming process, and as a result, typically only a small number (e.g. 2-3) of enquiries are made, which may not result in an accurate valuation, or the best resale value that may be available for that particular vehicle.

It is also difficult to provide an adequate description of the used vehicle in order to have the vehicle priced over the telephone, for example. Many factors associated with a used vehicle's condition, age, owner, type, and options for example, are often taken into account in the vehicle's price, and such information needs to be accurately conveyed in the description of the vehicle. Dealers may be hesitant to offer a guaranteed purchase price for a used vehicle being offered for resale without a complete description of the vehicle. Furthermore, different dealers or wholesalers may place different weights on different factors, resulting in different prices. Accordingly, where only a small number of enquiries are made, it may be more difficult for a dealer to find the best resale value for the used vehicle being purchased.

### SUMMARY OF THE INVENTION

The present invention relates to a system and method for facilitating the real-time pricing, sale and appraisal of used vehicles. In preferred embodiments of the invention, the invention relates to a computer-based system and method of collecting data supplied from buyers in constructing appraisal profiles, and for calculating, in real-time, a guaranteed price for a used vehicle having specific attributes as described by a seller based on the appraisal profiles. In a preferred embodiment of the invention, the system is accessible by users (e.g. buyers, sellers) over the Internet. A seller may be a vehicle dealer or a consumer, for example. The present invention effectively facilitates an instant sale of a vehicle at a price which reflects the demand for the vehicle by different dealers in one or more geographical areas.

According to one aspect of the present invention, the present invention is directed to a method of facilitating the real-time pricing, sale, and appraisal of a used vehicle comprising the steps of receiving input data and generating at least one associated appraisal profile for each of a first plurality of buyers, where the input data associated with an appraisal profile comprises check writing prices for a plurality of used vehicle models, where each check writing price represents a price offered by the respective buyer to purchase a used vehicle of a used vehicle model to which a plurality of base conditions apply; receiving a request from a seller for a guaranteed price for a specific seller-identified used vehicle, where the used vehicle model and actual condition of the seller-identified used vehicle are described in the request; generating in response to the request of a seller, at least one guaranteed price for the seller-identified used vehicle from the at least one appraisal profile; outputting the guaranteed prices to the seller, wherein the generating step comprises calculating at least one guaranteed prince for a seller-identified used vehicle from input data received from a buyer, wherein price adjustments are made to check writing prices received for a used vehicle model of the same model as the seller-identified used vehicle, wherein said price adjustments account for differences between the actual condition of the seller-identified used vehicle as described by the seller and the base conditions that apply to the used vehicle.

According to another aspect of the present invention, the present invention is directed to a system for facilitating the real-time pricing sale, and appraisal of a used vehicle comprising a system database comprising data received from buyers, the data associated with a plurality of appraisal profiles, where the data associated with an appraisal profile comprises check writing prices for used vehicle models, where each check writing price represents a price offered by a buyer to purchase a used vehicle of a used vehicle model to which a plurality of base conditions apply; a user interface for providing output to a seller and receiving details associated with a specific seller-identified used vehicle, where the model and actual condition of the seller-identified used vehicle are described; and at least one module connected to the database and the user interface, the modules programmed to generate at least one guaranteed price for the seller-identified used vehicle at the request of the seller, and for providing guaranteed prices for output to the seller through the user interface, wherein when generating the at least one guaranteed price for said seller-identified used vehicle, price adjustments are made to check writing prices for a used vehicle of the same model as the seller-identified used vehicle, wherein said price adjustments account for differences between the actual condition of the seller-identified vehicle as described by the seller and the base conditions that apply to the used vehicle model.

According to another aspect of the present invention, the present invention is directed to a system for facilitating the real-time pricing, sale, and appraisal of a used vehicle further comprising a messaging module for connection to a network, where the messaging module is programmed to send a price request to buyers for a guaranteed price for a seller-identified used vehicle, and to receive price requests from the buyers. In a preferred embodiment of the present invention, the network is a wireless network.

### BRIEF DESCRIPTION OF THE DRAWINGS

For a better understanding of the present invention, and to show more clearly how it may be carried into effect, reference will now be made, by way of example, to the accompanying drawings which show preferred embodiments of the present invention, and in which:

FIG. 1 is a schematic diagram illustrating a system in an embodiment of the present invention;

FIG. 2 is a schematic diagram illustrating a system comprising a web-based user interface in an embodiment of the present invention;

FIG. 3 is a flowchart illustrating steps in a method of facilitating the real-time pricing, sale and appraisal of a used vehicle in an embodiment of the present invention;

FIG. 4 is a flowchart illustrating steps to be performed in constructing an appraisal profile in an embodiment of the present invention;

FIG. 5 is a flowchart illustrating steps to be performed in pricing a used vehicle in an embodiment of the present invention;

FIGS. 6A to 6L are examples of screens displayed in a sample execution of an embodiment of the present invention; and

FIG. 7A to 7H are further examples of screens displayed in a sample execution of an embodiment of the present invention.

### DETAILED DESCRIPTION OF THE PREFERRED EMBODIMENTS

The present invention relates to a system and method for facilitating the real-time pricing, sale and appraisal of used vehicles. In the specification and in the claims, reference to the sale of a vehicle also includes a resale or remarketing of a vehicle. In preferred embodiments of the invention, the invention relates to a computer-based system and method of collecting data supplied from buyers (e.g. dealers) in constructing appraisal profiles, and for calculating, in real-time, a guaranteed price for a used vehicle having specific attributes as described by a seller based on the appraisal profiles. The guaranteed price is a price that is calculated on the basis of a buyer's appraisal profile, and which the buyer is bound to honor as the purchase price of the seller's used vehicle having attributes as described by the seller. The guaranteed price can also be referred to as a “check writing price” for the vehicle to be purchased by the buyer offering that price.

In addition to dealers, buyers can also refer to wholesalers, consumers, or any other individuals or organizations willing to honor a guaranteed purchase price for a used vehicle calculated on the basis of their appraisal profile provided to the system designed in accordance with the present invention. The seller can be a dealer, a wholesaler, a consumer, or any other individual or organization who wishes to appraise or obtain a guaranteed price for a used vehicle.

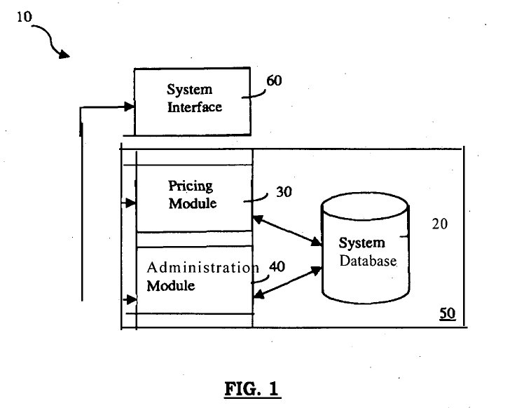

Referring to FIG. 1, an embodiment of a system for facilitating the real-time pricing, sale, and appraisal of a vehicle is shown generally as pricing system 10. Pricing system 10 comprises several components: a system database 20 for storing information such as, for example, vehicle prices, user data, appraisal profile data, vehicle data, dealer data, payment or accounting data, and any other data utilized by system 10; a first module shown as pricing module 30 programmed to calculate a guaranteed price for a vehicle from the data stored in system database 20, and a second module shown as administration module 40 programmed to maintain and update data stored in system database 20. In this embodiment of the present invention, system database 20, pricing module 30, and administration module 40 reside on application server 50, although in variant embodiments of the present invention, one or more of these components may reside on different servers.

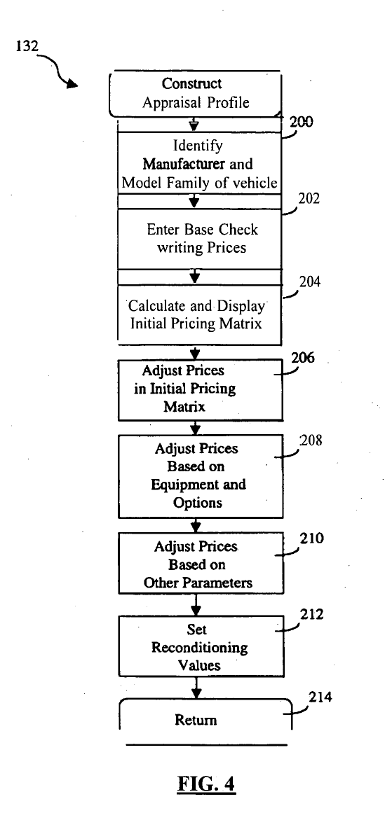

System 10 also comprises a system interface 60, through which data may be received as input and provided as output to buyers (e.g. dealers willing to purchase used vehicles for a guaranteed price) or sellers (e.g. dealers seeking to resell a used vehicle) of used vehicles. For example, data which comprises a buyer's appraisal profile will be entered through system interface 60 to be stored in system database 20 by administration module 40. The buyer's appraisal profile identifies the necessary prices and criteria required by pricing module 30 to calculate guaranteed prices to be offered to sellers for a variety of used vehicles. Examples of the prices and criteria necessary to generate a buyer's appraisal profile will be discussed in greater detail below with reference to FIG. 4. Data is also entered by sellers through system interface 60 to obtain a guaranteed price for their specific used vehicle being offered for sale. Data is collected from the seller by pricing module 30 including the make, model, and information on various aspects relating to the mechanical and visual condition of the vehicle for sale, for example. Furthermore, in maintaining and updating the data in system database 20, the administration module 40 may also communicates with users (e.g. buyers, sellers, and administrators of pricing system 10) through system interface 60.

Preferably, system interface 60 is web-based, allowing users to access data in system database 20 through the pricing module 30 and administration module 40 via the Internet.

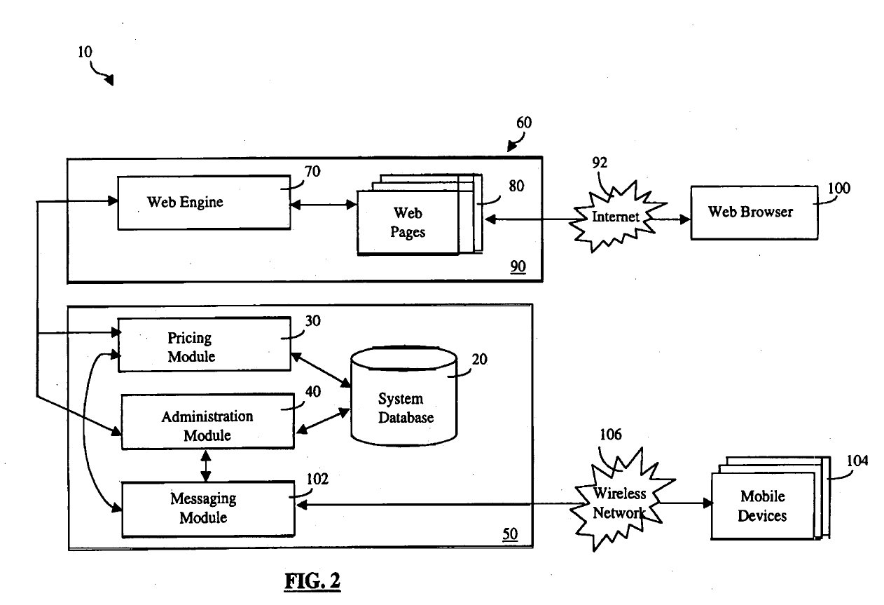

Referring to FIG. 2, an embodiment of the present invention where the system interface 60 is web-based, is shown. System interface 60 comprises a web engine 70 connected to pricing module 30 and administration module 40. Web engine 70 generates the contents of web pages 80 using data obtained through pricing module 30 and administration module 40. Web engine 70 and web pages 80 may reside on a separate web server 90. Web pages 80 are accessible over the Internet 92 by a user, through the user's web browser 100. In variant embodiments of the invention, web pages 80 may be accessible by users through other means, including closed or private networks, for example.

In the preferred embodiment of the invention, as illustrated with reference to FIG. 2, pricing system 10 further comprises a messaging module 102 adapted to send and receive messages to and from mobile devices 104 through a wireless network 106. Messages may be transmitted (i.e. sent to mobile devices 104 and/or sent by mobile devices 104) as electronic mail messages, pages, or in other forms. Messages are preferably text-based for quick transmission, but may also be in other formats, including HTML-based documents, for example. Mobile devices 104 can include personal digital assistants (PDAs), cellular telephones, pagers, portable electronic mail messaging or other messaging devices, handheld organizers, portable computing devices or other devices.

As an example, messages sent by messaging module 102 to mobile devices 104 may include a request for a guaranteed price for a specific used vehicle being offered for sale by a seller. A buyer (e.g. a dealer) would receive the request on his mobile device 104 as a personalized electronic mail message, describing the used vehicle. The buyer would then send a reply message to the messaging module 102 of pricing system 10 that includes a guaranteed price for the vehicle. This guaranteed price can be relayed to the seller (or used in some other manner) for further consideration.

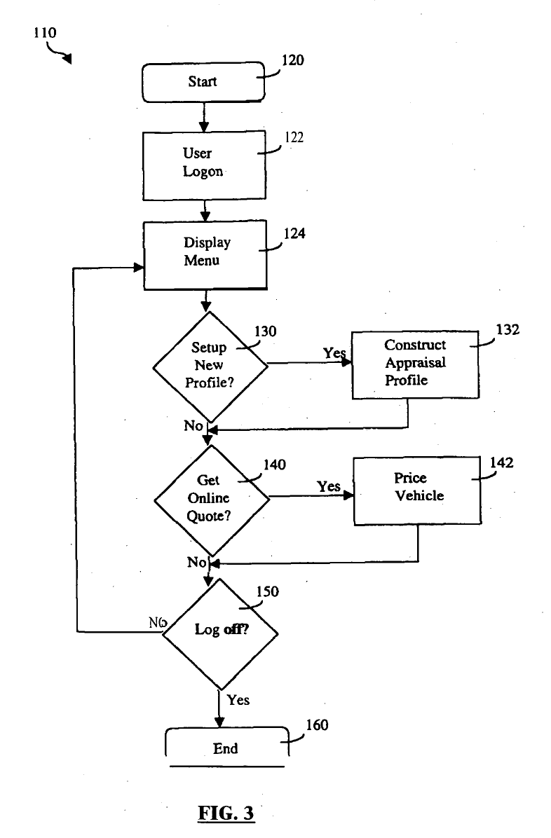

In a preferred embodiment of the invention, system 10 is used to facilitate the real-time pricing, sale, and appraisal of a used vehicle between a first vehicle dealer (“seller”) and a second vehicle dealer (“buyer”). Such transactions may be referred to as “dealer-to-dealer” or “business-to-business” transactions. The present invention allows for the efficient resale or remarketing of used vehicles between dealers, increasing the likelihood that a seller will receive the best price for his used vehicle (e.g. as obtained from a consumer as a “trade-in”), and that the buyer will be able to purchase a used vehicle at a price that reflects his valuation of the vehicle, based on local demand or other factors. An embodiment of a method of facilitating the real-time pricing, sale, and appraisal of a used vehicle in the context of dealer-to-dealer transactions is described below with reference to FIGS. 3 to 5.

Referring to FIG. 3, steps in an embodiment of a method of facilitating the real-time pricing, sale, and appraisal of a vehicle are shown generally as 110, and commences at step 120. At step 122, a user logs on to the pricing system (e.g. pricing system 10 of FIG. 2), by identifying himself using a logon name and password, for example. Other means of providing users with access to the pricing system may be implemented as known in the art. In this embodiment of the invention, the user is a vehicle dealer who is permitted to both construct his own appraisal profiles for use in calculating guaranteed prices for vehicles he may wish to purchase, and to obtain quotes for guaranteed prices for vehicles he may wish to sell using the pricing system (i.e. the vehicle dealer can be both a “buyer” and a “seller”). However, the pricing system may also be designed to limit what specific tasks may be performed by any particular user. For example, a user may be permitted to obtain quotes for a guaranteed price for a vehicle as a seller, but not to construct appraisal profiles as a buyer, and vice-versa. As a further example, different employees from the same vehicle dealership may be permitted access to the pricing system, with each employee permitted to perform only certain pre-defined tasks.

At step 124, a menu is displayed to the user. The user selects a task to perform from those displayed in the menu. If at step 130, the user has requested that an appraisal profile be set up to price a vehicle for which an appraisal profile has not yet been constructed, then a new appraisal profile will be constructed at step 132. If at step 140, the user has requested a quote for a guaranteed price on a used vehicle, then the vehicle will be priced at step 142. If at step 150, the user has made a request to log off the pricing system, method 110 will terminate at step 160; otherwise, the flow of method steps proceeds back to step 124, at which the pricing system will wait for a selection by the user from the menu.

It will be obvious to those skilled in the art that many other functions may be implemented in the pricing system without departing from the spirit of the present invention. For example, the pricing system can be adapted to permit previously constructed appraisal profiles to be amended (e.g. adjusting previously entered prices) or deleted by users, generate reports based on previously obtained quotes or inventory data, and permit user data and system access profiles to be set up or amended.

Referring to FIG. 4, a flowchart illustrating the steps to be performed in constructing an appraisal profile in an embodiment of the present invention at step 132 of FIG. 3, is shown. In constructing appraisal profiles, prices for a variety of used vehicles will be generated, which will form the basis for calculating a guaranteed price for a used vehicle for sale, as at step 142 of FIG. 3. In this embodiment of the invention, the prices generated and the inputs received from users in constructing an appraisal profile are stored in a system database (e.g. system database 20 of FIG. 2) by an administration module for example (e.g. administration module 40 of FIG. 2), for later use by the pricing system. The “user” performing steps described herein with reference to FIG. 4 acts as a “buyer” of used vehicles. Most preferably, the steps shown in FIG. 4 will be performed for multiple model families of vehicles, by multiple buyers (e.g. vehicle dealers), to allow the pricing system to generate a large number of guaranteed prices for different vehicles. Each individual buyer will construct an appraisal profile for each model family of used vehicles for which he is willing to offer a guaranteed price.

At step 200, the user identifies the manufacturer and model family of a vehicle. This can be done, for example, by selecting a manufacturer and model family from a drop-down list of pre-defined choices.

At step 202, the user enters his base check writing price for specific vehicles from the manufacturer and model family identified at step 200. In order to facilitate this, the pricing system may display a list of different vehicle models (“trim levels”) from the manufacturer and model family identified at step 200, and identify a set of base conditions that the user is to assume applies to the vehicle model being priced (e.g. assume that the vehicle of the specified model has 15,000 kilometers, is fully equipped with all available factory options, and requires no reconditioning). A year of manufacture for each vehicle model in the displayed list is also specified. Under these conditions, the user would enter his corresponding base check writing price for each of the vehicle models in the displayed list. Each base check writing price entered here is the price that he would be willing to purchase a vehicle of the specified vehicle model manufactured in the specified year, based on the set of base conditions provided.

Each base check writing price entered at step 202 can be subsequently used as a benchmark to price other vehicles for sale under different conditions. This eliminates the need for vehicle dealers to enter multiple prices for vehicles in different conditions, which makes the vehicle pricing process more efficient since the actual condition of potential vehicles for sale can vary widely.

At step 204, the pricing system calculates and displays an initial pricing matrix of vehicle prices, taking into account the base check writing prices entered at step 202, and pre-set yearly depreciation factors. Each cell in the initial pricing matrix contains a check writing price for a vehicle of a specific vehicle model manufactured in a specific year. The check writing price for the cell is calculated by adjusting the base check writing price for the vehicle model so as to account for appreciation/depreciation between a vehicle manufactured in the specific year associated with the cell and a vehicle manufactured in the year associated with the base check writing price, in accordance with the pre-set yearly depreciation factors.

At step 206, the user can adjust the yearly depreciation factors and request a recalculation of the check writing prices in the initial pricing matrix. The user may also be permitted to adjust the prices in a cell by a specific percentage or dollar amount. For example, if the user is willing to pay an extra $1,000 for a specific vehicle model manufactured in 1999, the user can specify that the check writing prices for all 1999 vehicles be adjusted accordingly. The user can adjust the prices in the initial pricing matrix, which are still based on the base conditions identified at step 202, until the prices reflect the manner in which he appraises vehicles.

At step 208, the user can assign adjustment factors to equipment and options for one or more vehicle models, which are to be used to adjust check writing prices for those vehicle models. For example, if the base conditions identified at step 202 indicate that the base check writing price for a given vehicle model should be entered by a user based on vehicles that are “fully-loaded” (equipped with all options available for that particular vehicle model), adjustments will need to be made when pricing used vehicles that are not fully-loaded. Accordingly, at step 208, the user can assign, for each equipment components or option, an incremental amount that is to be added or subtracted (specified by the user) to the check writing price of a used vehicle that is not equipped with that equipment component or option. In this example, a user could assign an adjustment factor of −$1500.00 to the “air conditioning” option, which would indicate that the check writing price of a used vehicle without air conditioning should be adjusted lower by $1500.00. The value of this deduction may be subsequently adjusted to reflect the yearly depreciation factor as indicated earlier by the user.

In preferred embodiments of the invention, default adjustment factors may also be pre-set for different equipment components or options of different vehicle models.

Furthermore, in preferred embodiments of the invention, the pricing system may also be designed to “red light” used vehicles that are equipped with an undesired option and/or are not equipped with a desired option. For example, the user may set a “red light” flag to indicate that he is not willing to purchase any vehicles that are not equipped with air conditioning. Conversely, the user may set a “red light” flag to indicate that he is not willing to purchase any vehicles that are equipped with air bags. Accordingly, when a request is made by a seller for a guaranteed price for such vehicles, the pricing system will not calculate a price for those vehicles based on that user's appraisal profile.

At step 210, the user can assign adjustment factors based on other parameters for a model family. These other parameters will typically include, but are not limited to, disclaimers that may be important to experts in appraising vehicles. For example, the user can assign an adjustment factor to: a vehicle that has or has not undergone a complete repaint; a vehicle that has or has not previously been used as police car, taxi, or rental car; a vehicle that has or has not been a recovered stolen vehicle; or a vehicle that has or has not been an insurance write-off. Accordingly, at step 210, the user can assign, for each parameter, an incremental amount that is to be added or subtracted (as defined by the user) to the check writing price of a used vehicle where each parameter applies. In this example, a user could assign an adjustment factor of −$2000.00 to a “has been a rental car” parameter, which would indicate that the check writing price of a used vehicle that was previously used as a rental car should be adjusted lower by $2000.00.

In preferred embodiments of the invention, default adjustment factors may be pre-set and associated with different parameters for different model families or vehicles models, to be used by the pricing system.

Furthermore, in preferred embodiments of the invention, the pricing system may also be designed to “red light” used vehicles to which a particular parameter applies. For example, the user may set a “red light” flag to indicate that he is not willing to purchase any vehicles that have been previously used as rental cars. Accordingly, when a request is made by a seller for a guaranteed price for such vehicles, the pricing system will not calculate a price for those vehicles based on that user's appraisal profile.

At step 210, the user can also assign adjustment factors based on other parameters for a model family such as a used vehicle's exterior or interior color. Different adjustment factors can be assigned to vehicles of different exterior or interior colors, to be used in adjusting check writing prices higher or lower as desired, depending on the specified color. The user may also “red light” vehicles to which these parameters apply. For example, the user may set a “red light” flag to indicate that he is not willing to purchase any vehicles that have a purple exterior, or a bright red interior. Accordingly, when a request is made by a seller for a guaranteed price for such vehicles, the pricing system will not calculate a price for those vehicles based on that user's appraisal profile.

At step 212, the user sets reconditioning values for used vehicles in each model family. Generally, reconditioning values are the costs related to repair, replace, or install damaged or missing components or aspects (i.e. defects) of a used vehicle. When a used vehicle is being resold, there will typically be various mechanical components (e.g. alignment, front brakes, rear brakes, tires, air conditioning shocks, steering, power locks, power windows, etc.) or visual aspects (e.g. body dents, body rust, body, stone chips, damaged or worn carpets, etc.) of the vehicle that can be identified for repair or replacement. The estimated cost of repair, replacement, or installation of each defect identified by the pricing system is entered by the user at this step, which is to be ultimately factored into the check writing price or guaranteed price to be offered for vehicles being sold having those defects.

Users may also be given the option of selecting one or more reconditioning “packages”, which provide for a set of pre-defined reconditioning values for various vehicle models, for example. These packages may be used to simplify the pricing procedure for the user, by assigning default reconditioning values to particular reconditioning items.

Users may also be given the option of setting maximum reconditioning value limits for use in pricing used vehicles. For example, the user may wish to set a maximum cost or charge for visual defects, and/or a maximum charge for mechanical defects. Any used vehicle that requires a reconditioning at a cost greater than the maximum charge is effectively “red-lighted”, and will not be priced based on that user's appraisal profile. Other types of limits may also be defined in the pricing system, and set by users.

The steps to be performed in constructing an appraisal profile are completed at step 214. It Will be obvious to those skilled in the art that in variant embodiments of the invention, different steps may be performed in constructing appraisal profiles and/or additional steps may be added to allow additional data to be obtained from users for subsequent use in the pricing of used vehicles.

As each user acting as a buyer of used vehicles is provided with the capability of placing his own values for each standard or optional equipment of a vehicle, mechanical reconditioning factor, visual reconditioning factor, and any other factor that may be used in describing a vehicle, a range of pre-set values for vehicles can be calculated by the pricing system. Accordingly, the pricing system's ability to harness and compare the value discrepancies across numerous users makes the system a powerful vehicle appraisal tool.

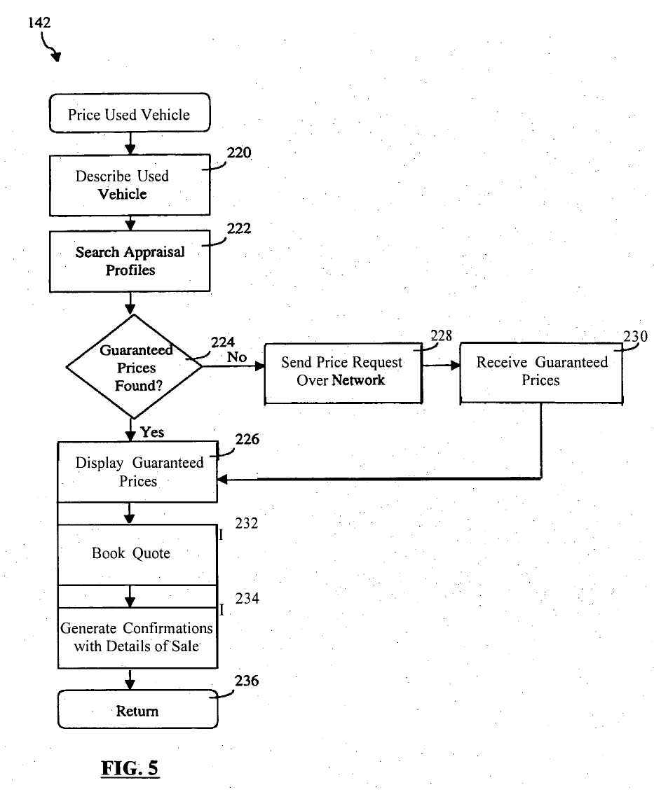

Referring to FIG. 5, a flowchart illustrating the steps to be performed in the real-time pricing, sale, and appraisal of a used vehicle in an embodiment of the present invention at step 142 of FIG. 3, is shown. In this embodiment of the invention, the prices generated and the inputs received from buyers in constructing an appraisal profile as stored in a system database (as described earlier with reference to FIG. 4) are used by the pricing system to price the used vehicle. A “user” performing the steps described herein with reference to FIG. 5 acts as a “seller” of a used vehicle.

At step 220, the user describes the used vehicle being offered for sale by entering information pertaining to the vehicle into the pricing system, through a pricing module or pricing engine for example (e.g. pricing module 30 of FIG. 2). The user is led through a series of screens so that they can describe, for example, the make, model, trim level, year, standard and optional equipment, mileage, mechanical reconditioning factors, and visual reconditioning factors of the vehicle. Other information may also be obtained from a user at step 220, including whether the vehicle was a trade-in, the number of previous owners of the vehicle for sale, and whether the vehicle for sale has been repainted or has been in an accident, for example. In variant embodiments of the invention, at step 220, an indication of the location of the user (e.g. postal code) may also be obtained.

At step 222, the pricing engine initiates a search through the appraisal profiles for which data is stored in the system database. The pricing engine attempts to determine guaranteed prices or check writing prices for the vehicle that can be generated from the appraisal profiles, and calculates the guaranteed prices where possible. Each guaranteed price can be calculated, for example, by retrieving the base check writing price established in the appraisal profile of each buyer that has been constructed for the specific make and model of the vehicle, and subsequently making the necessary value/cost adjustments as indicated in the appraisal profiles in order to take into account the specific features, factors, and options associated with the used vehicle being offered for sale as described at step 220. In embodiments of the invention where buyers were permitted to “red light” specific features, factors, or options, a guaranteed price would not be generated if the vehicle being priced contained the specific feature, factor, or option so flagged.

At step 224, if guaranteed prices could be generated based on the appraisal profiles, these prices are then displayed at step 226. Otherwise, if no guaranteed prices could be generated based on the appraisal profiles (e.g. no appraisal profiles have been constructed for the particular model of used vehicle being priced, or the used vehicle contains one or more features that have been “red-lighted” in each of the applicable appraisal profiles), then at step 228, the pricing system will send a price request to dealers in an effort to obtain at least one guaranteed price for the user, in real-time. In a preferred embodiment of the invention, the price request is sent to participating buyers (e.g. dealers and wholesalers) over a “live” wireless network. The individual dealers and wholesalers are equipped with wireless handheld devices (e.g. Research in Motion Limited's Blackberry™ pagers), who receive price requests as electronic mail messages that contain a complete description of the used vehicle being offered for sale, as obtained at step 220. Upon receiving the price request, the dealer or wholesaler can reply to the pricing system (e.g. by sending a reply electronic mail message) and provide a value (“bid”) on the particular vehicle. The bids are received by the pricing system at step 230, and represent that dealer's or wholesaler's guaranteed price to be offered for the purchase of that vehicle. As the bids are received by the system, they can be subsequently displayed to the user at step 226.

In variant embodiments of the invention, the pricing system may be adapted to retrieve bids from the live network whether or not the pricing system is able to generate pre-set guaranteed prices based on the appraisal profiles.

At step 232, the user requesting guaranteed prices for the vehicle examines the prices displayed, and can accept a price (i.e. “book a quote”) being offered by a particular buyer by choosing the price (usually the highest price) to sell the vehicle for. Accordingly, a sale of the used vehicle from seller to buyer is effected at this step.

In variant embodiments of the invention, other costs associated with the sale of the used vehicle to a particular buyer (e.g. delivery or administrative costs associated with the transfer of the used vehicle to the buyer) may be itemized by the pricing system and displayed to the user, so that the user may take into account these other costs before selecting a buyer for the used vehicle being sold.

At step 234, documents confirming the sale are generated by the pricing system. A first confirmation can be generated for display to the user selling the vehicle and for printing, or sent by electronic mail or by facsimile to the user, for example. The confirmation may include for example, buyer information, delivery and administrative details, and costs. A second confirmation can also be generated and sent to the buyer (e.g. by electronic mail or facsimile) to confirm the sale. This confirmation will also further include the guaranteed price which the buyer has agreed to pay for the used vehicle, if it has been accurately described by the seller.

The steps to be performed in pricing a used vehicle are completed at step 236. It will be obvious to those skilled in the art that different steps and/or additional steps may be performed to price and sell a used vehicle without departing from the scope of the present invention.

An embodiment of a method of facilitating the real-time pricing, sale and appraisal of a used vehicle in the context of dealer-to-dealer transactions was described above with reference to FIGS. 3 to 5. In variant embodiments of the present invention, the pricing system designed in accordance with the present invention and methods for pricing used vehicles may be modified to permit consumers to obtain and/or offer guaranteed prices for used vehicles. This would provide a means for consumers who are less comfortable or less skilled at negotiation to avoid having to do so. Furthermore, as the guaranteed price is to be honored by a vehicle dealer, the risks largely associated with the sale of vehicle in consumer-to-consumer transactions are greatly reduced.

Where the user of the pricing system is a not a dealer but a consumer, it may be desirable to limit the functions available to the user, or the information that may be displayed to the user. For example, the pricing system may be adapted to perform one or more of the following:

(a) permit the user to only offer vehicles for sale (and not to construct appraisal profiles);

(b) permit the user to receive a guaranteed price only from a pre-specified number of vehicle dealers located closest to the user;

(c) permit the user to receive only one “final” guaranteed price which is some function (e.g. an average) of all generated guaranteed prices, where any participating vehicle dealer must honor the “final” guaranteed price (but that dealer may be able to resell it to a different dealer for a higher pricing using the pricing system);

(d) permit the user to receive certain information (e.g. dealer information) upon payment of a commission or service fee; and

(e) permit the user to only receive dealer information or a guaranteed price from the dealer closest (i.e. geographically) to the user.

Other adaptations and modifications may be implemented to permit consumers and/or other users to use the pricing system.

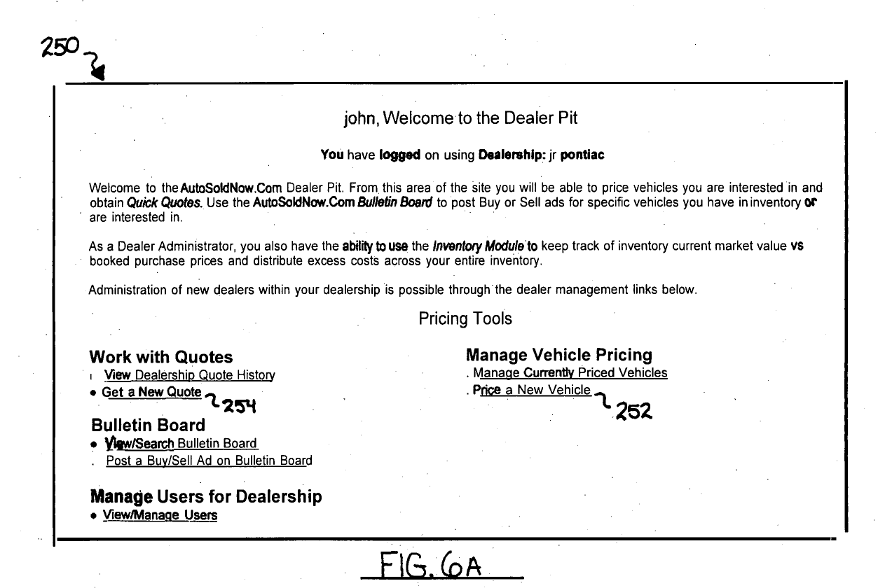

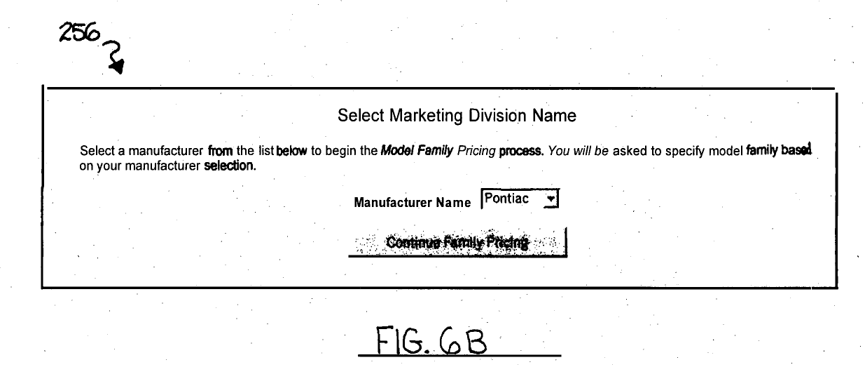

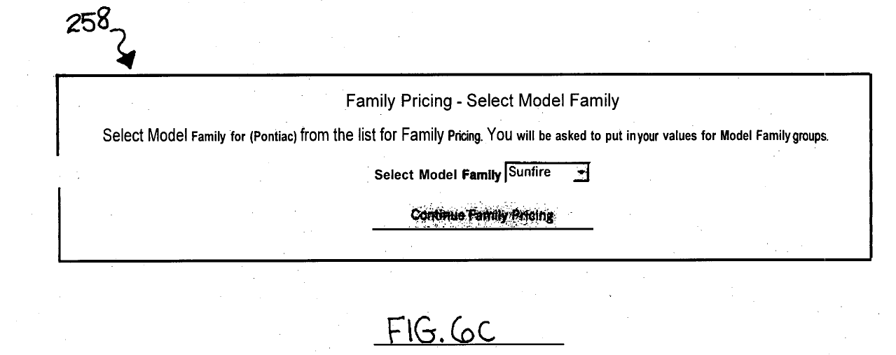

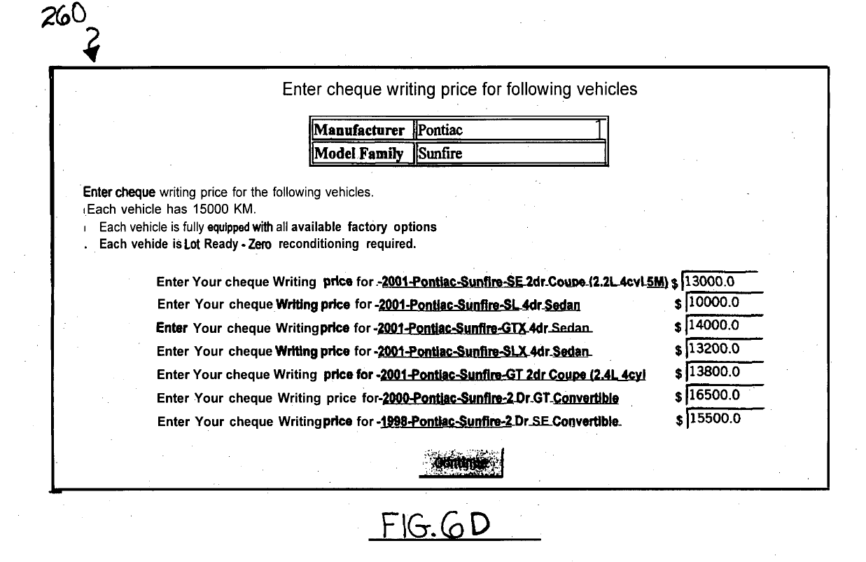

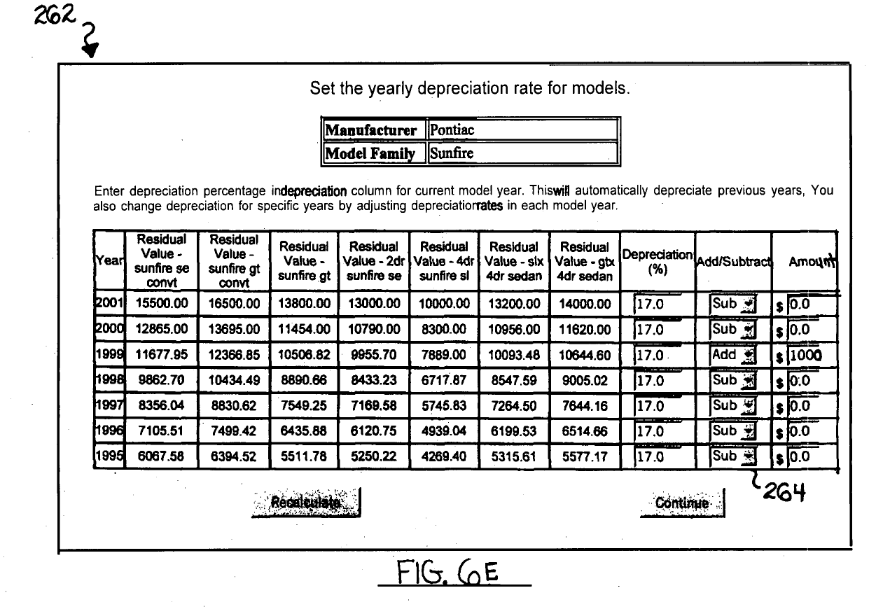

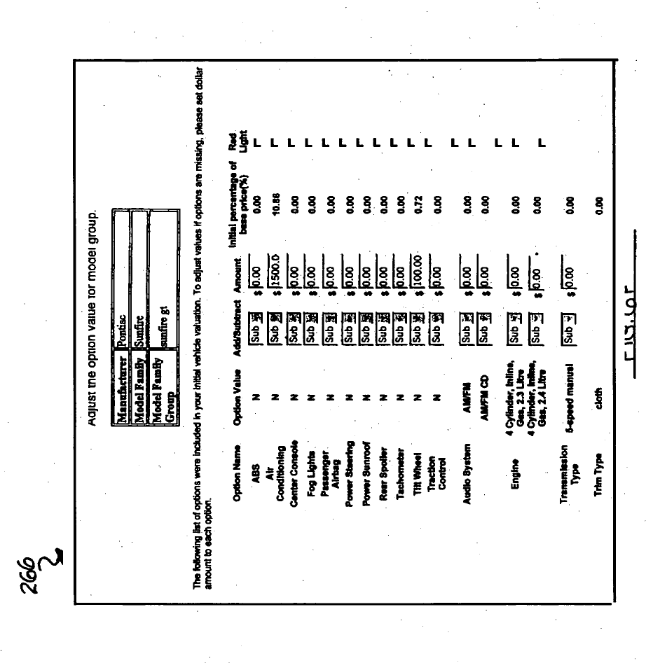

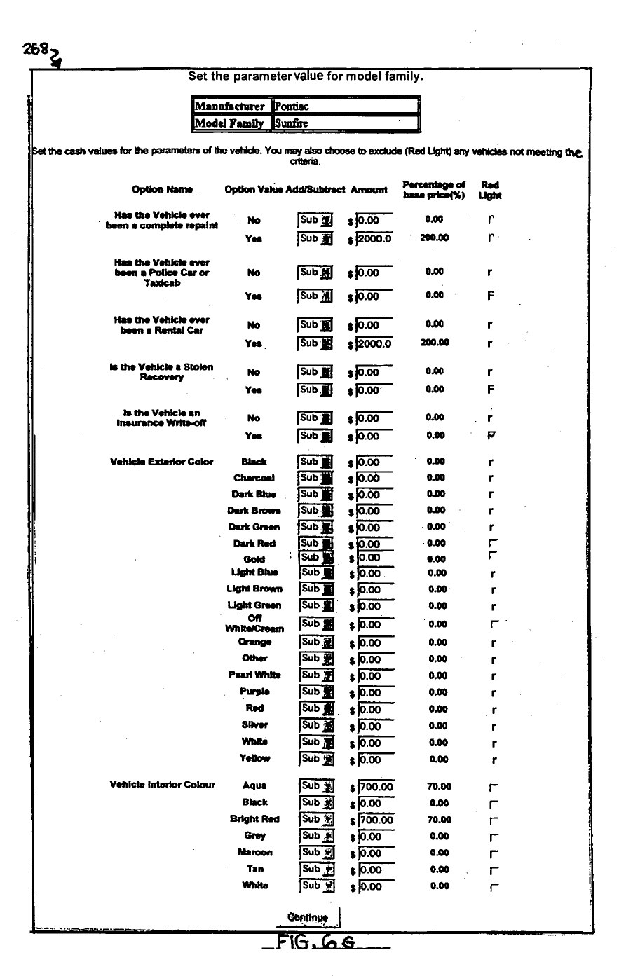

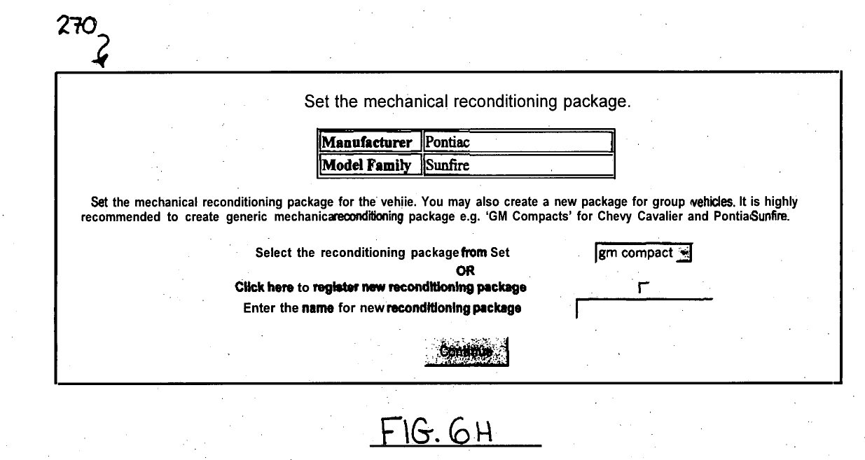

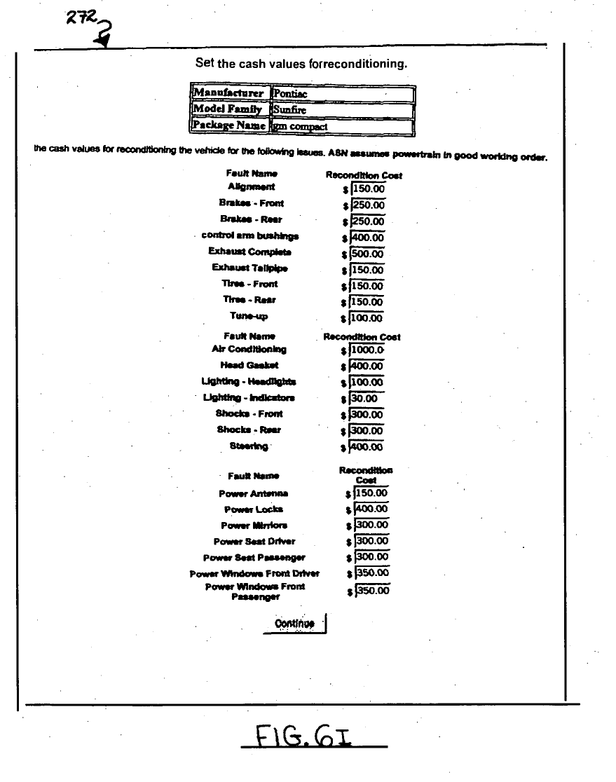

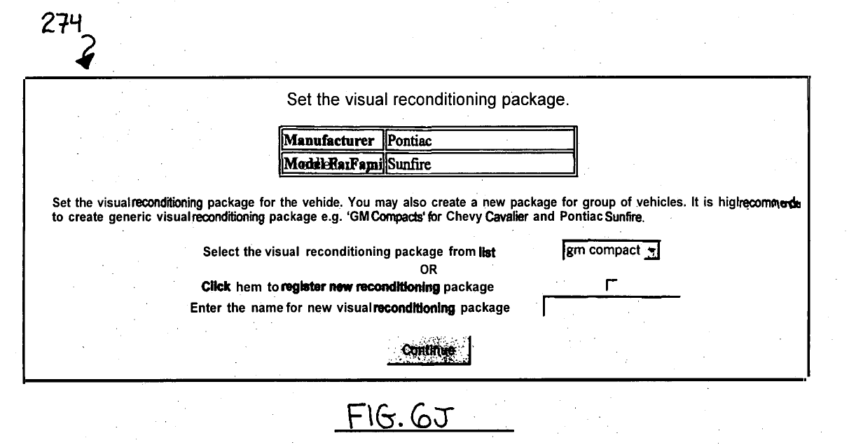

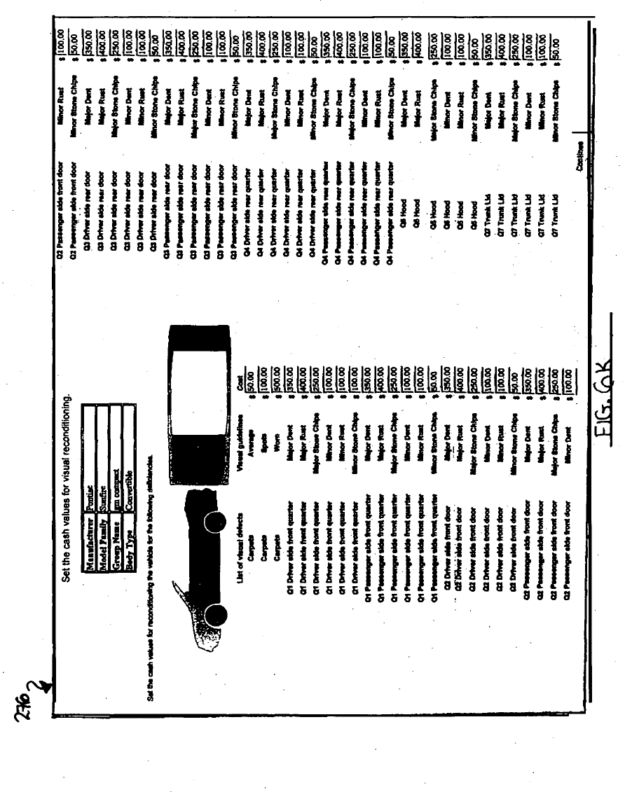

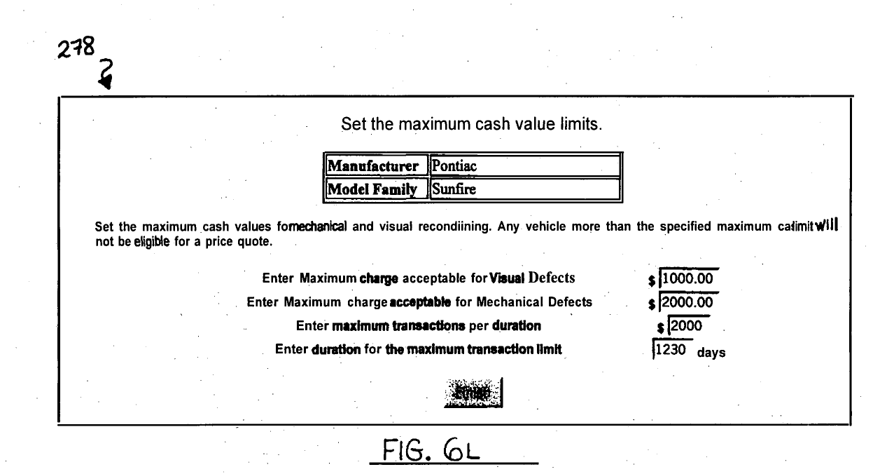

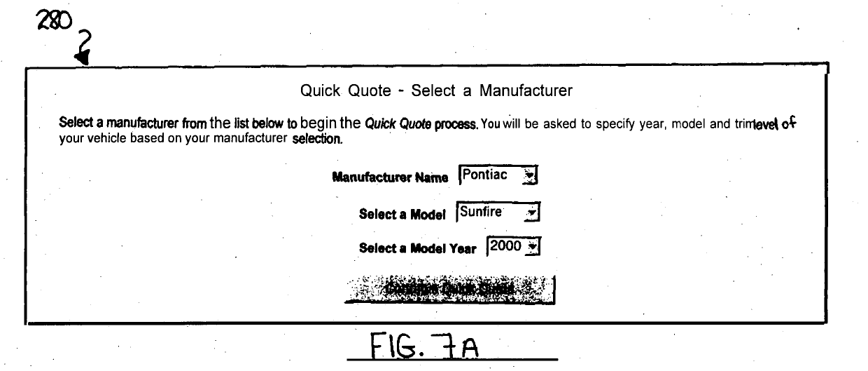

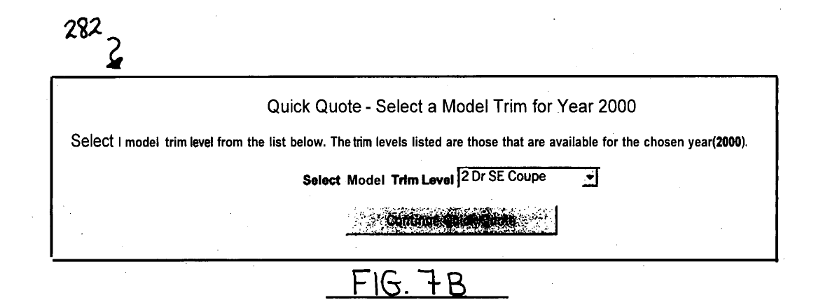

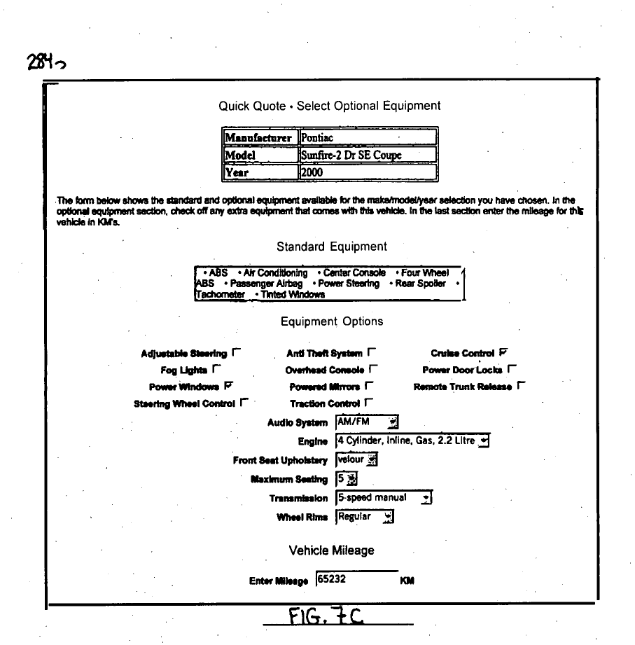

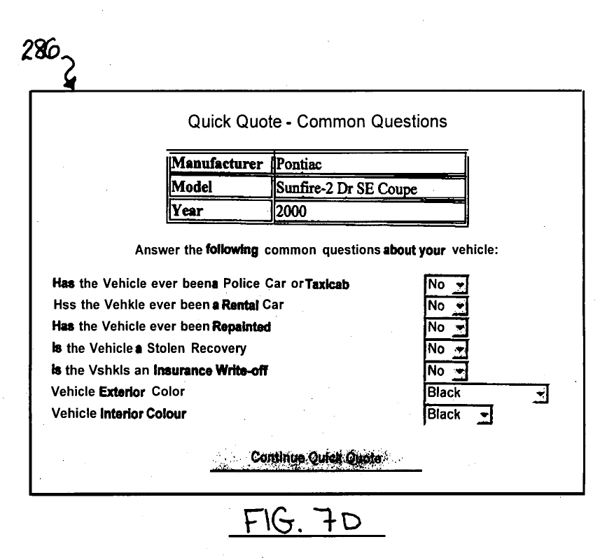

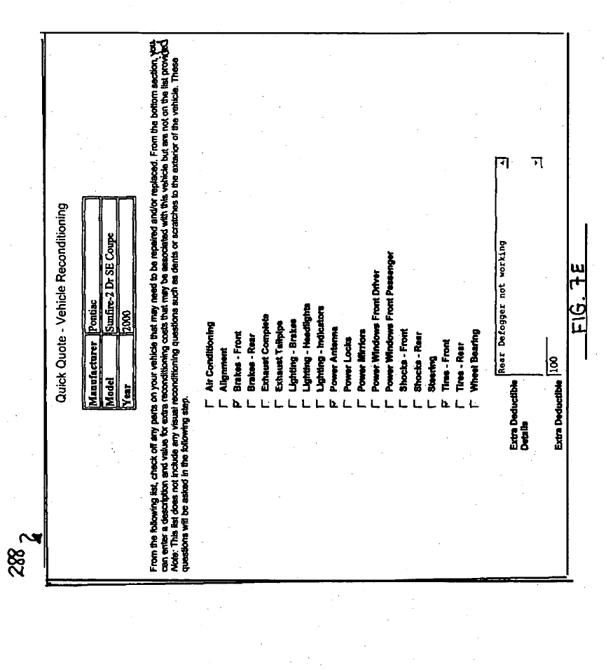

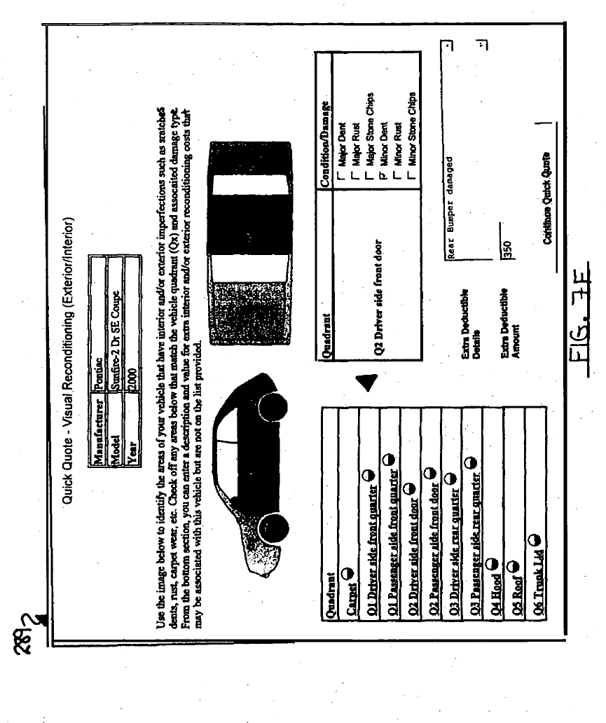

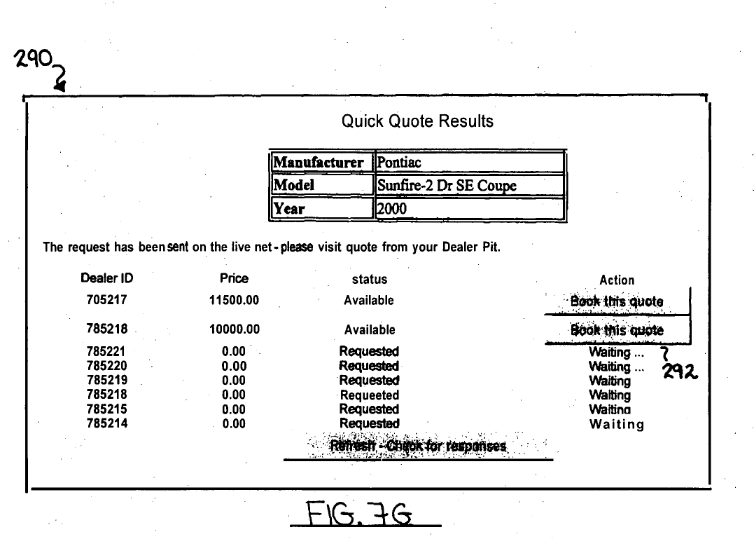

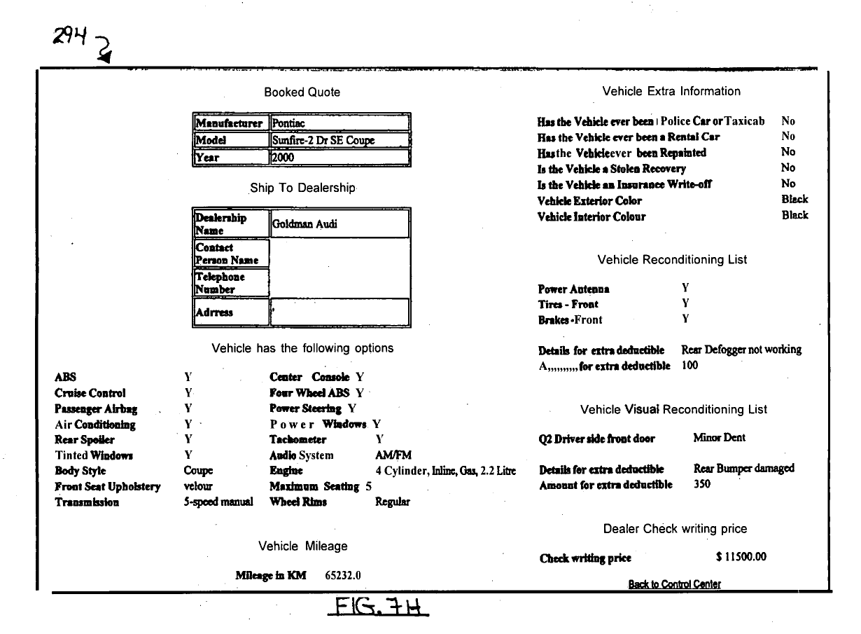

Screens seen in a web browser 100 (FIG. 2) in a sample execution of a web-based embodiment of the present invention are illustrated in FIGS. 6A to 6L, and in FIGS. 7A to 7H. These figures are provided as an example only; it will be obvious to those skilled in the art that many different variations and modifications can be made to the output formats, styles, screens, and user interfaces without departing from the scope of the present invention.

FIG. 6A is an example of a main menu 250, providing users with a first link 252 to be selected if the user wishes to construct an appraisal profile for use in pricing used vehicles, and a second link 254 to be selected if the user wishes to obtain a quote for a guaranteed price for a specific used vehicle. Other links may be selected that allow the user to perform other functions as permitted by the pricing system in an implementation of the present invention.

FIGS. 6B to 6L illustrate an example where the user selected first link 252 of main menu 250 of FIG. 6A to construct an appraisal profile. FIG. 6B illustrates a screen 256 where a manufacturer is selected. FIG. 6C illustrates a screen 258 where a model family for the manufacturer is selected. FIG. 6D illustrates a screen 260 where the user enters check writing prices for various specified vehicles in the model family. FIG. 6E illustrates a screen 262 where a depreciation matrix 264 has been generated. Fields of the depreciation matrix 264 may be modified by the user, and the values in the depreciation matrix 264 may be recalculated based on the modified fields. FIG. 6F illustrates a screen 266 where option values for the model family are set. FIG. 6G illustrates a screen 268 where parameters for the model family are set. FIG. 6H illustrates a screen 270 where a user can select a pre-defined mechanical reconditioning package, and FIG. 6I illustrates a screen 272 where the user can modify values related to mechanical reconditioning costs. Similarly, FIG. 6J illustrates a screen 274 where a user can select a pre-defined visual reconditioning package, and FIG. 6K illustrates a screen 276 where the user can modify values related to visual reconditioning costs. FIG. 6L illustrates a screen 278 where a user can enter maximum charges for mechanical and visual reconditioning costs.

FIGS. 7A to 7H illustrate an example where the user selected second link 254 of main menu 250 of FIG. 6A to price a specific used vehicle. FIG. 7A illustrates a screen 280 where a manufacturer, model, and model year of the used vehicle is identified. FIG. 7B illustrates a screen 282 where a specific model trim level for the identified model year is selected. FIG. 7C illustrates a screen 284 where the equipment and options of the specific used vehicle are identified. FIG. 7D illustrates a screen 286 where users are asked questions corresponding to parameters that have been previously set by buyers, which may affect the price of a used vehicle. FIG. 7E illustrates a screen 288 where the user identifies what mechanical reconditioning may be required of the vehicle. FIG. 7F illustrates a screen 289 where the user identifies what visual reconditioning may be required of the vehicle.

FIG. 7G illustrates a screen 290 which may be displayed when no guaranteed prices could be generated by the pricing system, and a price request has been sent to dealers and wholesalers on the “live” wireless network. As dealers and wholesalers reply with prices (“bids”) for the used vehicle, they are displayed to the user on screen 290 in real-time. Users may select a guaranteed price by selecting the corresponding action button 292. FIG. 7H illustrates a screen 294 displaying an example of a confirmation of the appraisal, pricing, and sale transaction.

In variant embodiments of the invention, the pricing system may be designed to obtain check writing prices for used vehicles of different model families with numerous different pre-defined sets of options and parameters, instead of permitting the user to define individual incremental adjustment factors. However, in preferred embodiments of the invention, the use of incremental adjustment factors for options and other parameters allows appraisal profiles to be constructed more efficiently and permits a broader range of used vehicles of varying conditions (e.g. mechanical and visual) to be appraised and priced.

In variant embodiments of the present invention, users of the pricing system are not limited to consumers, vehicle dealers, and/or wholesalers. Anyone who wishes to have access to immediate pricing information for vehicles may be set up as users of the pricing system. These other users may also be referred to as “information subscribers”. For example, organizations such as insurance companies in need of a real-time price for a damage claim for a particular make of vehicle, or a financial institution in need of a price on a repossessed vehicle may use the pricing system to obtain a guaranteed price for a specific used vehicle.

In variant embodiments of the present invention, it will be obvious to those skilled in the art that there are numerous possible configurations of the system interface and other components of the pricing system, in a web-based or other implementation of the present invention. Modifications to the pricing system to permit the performance of secured transactions can be made in known manner, for example. Components of application servers (e.g. application server 50 of FIG. 2) and web servers (e.g. web server 90 of FIG. 2) can be combined on a single server or distributed across several servers as desired. Firewalls may be implemented in the pricing system to prevent unauthorized access to private information. Additional components to facilitate the collection of fees or commissions from users may also be implemented.

In variant embodiments of the present invention, the user interface may not be web-based, but instead may be an interface made available to users on a private or internal network. The user interface may also be designed to permit users to communicate with modules of the pricing system through an automated telephone system, which prompts callers to enter information using a telephone keypad and which transmits information to the pricing system. Alternatively, the user interface may be used by an human operator, where consumers may call into a call center and provide information to the operator over the telephone, for example.

With respect to elements of the pricing system for facilitating the pricing and sale of a vehicle as described in this specification, it will be apparent to those skilled in the art that the execution of various tasks associated with the methods of the present invention need not be performed by the particular component specified in the description of the preferred and variant embodiments of the invention, and that many configurations of the pricing system are possible without departing from the scope of the present invention. For example, it will be obvious to those skilled in the art that the performance of tasks by a pricing module may be performed by a different module, or through the use of multiple modules. As a further example, the steps performed by an administration module may instead be performed by the pricing module, and/or other module(s). It will also be obvious to those skilled in the art that the information stored in the system database may be distributed across multiple storage means.

The present invention has been described with regard to preferred embodiments. However, it will be obvious to persons skilled in the art that a number of variants and modifications can be made without departing from the scope of the invention as described herein.

1. A method of facilitating the real-time pricing, sale, and appraisal of a used vehicle, said method comprising the steps of:
a) for each of a first plurality of buyers, receiving input data and generating at least one associated appraisal profile, wherein the input data associated with an appraisal profile comprises check writing prices for a plurality of used vehicle models, wherein each check writing price represents a price offered by the respective buyer to purchase a used vehicle of a used vehicle model to which a plurality of base conditions apply;
b) receiving a request from a seller for a guaranteed price for a specific seller-identified used vehicle, wherein the used vehicle model and actual condition of said seller-identified used vehicle are described in said request;
c) generating, in response to said request of said seller, at least one guaranteed price for said seller-identified used vehicle from the at least one appraisal profile; and
d) outputting said at least one guaranteed price to said seller;
wherein said generating step comprises calculating said at least one guaranteed price for said seller-identified used vehicle from input data received in step (a), wherein price adjustments are made to check writing prices received in step (a) for a used vehicle model of the same model as said seller-identified used vehicle, wherein said price adjustments account for differences between the actual condition of said seller-identified used vehicle as described by the seller in step (b) and the base conditions that apply to said used vehicle model.

2. The method as claimed in claim 1, wherein the input data associated with each appraisal profile includes a plurality of adjustment values to be used in making price adjustments for calculating prices for seller-identified used vehicles.

3. The method as claimed in claim 2, wherein step (c) comprises the substeps of:
i. attempting to calculate at least one first guaranteed price for said seller-identified used vehicle from input data received in step (a), wherein price adjustments are made to check writing prices received in step (a) for used vehicle models of the same model as said seller-identified used vehicle, wherein said price adjustments account for differences between the actual condition of said seller-identified used vehicle and the base conditions that apply to said used vehicle model;
ii. retrieving said at least one first guaranteed price if calculated in substep (i);
iii. attempting to retrieve at least one second guaranteed price from a second plurality of buyers, initiated by sending a price request to said second plurality of buyers over a network;
iv. retrieving said at least one second guaranteed price if calculated in substep (iii); and
v. outputting said at least one first guaranteed price if retrieved in substep (ii) and said at least one second guaranteed price if retrieved in substep (iv).

4. The method as claimed in claim 3, wherein said network is a wireless network.

5. The method as claimed in claim 2, wherein each of said plurality of adjustment values represents an incremental amount associated with a difference between the actual condition of a seller-identified used vehicle and the base conditions that apply to the used vehicle model of said seller-identified used vehicle selected from the following group: the presence or absence of at least one specific option; the presence or absence of at least one specific equipment component; the application of at least one specific parameter; the need to recondition at least one specific mechanical component; the need to recondition at least one specific visual aspect; the presence or absence of at least one pre-specified factor.

6. The method as claimed in claim 5, wherein each of said at least one specific option is selected from the group consisting of: ABS, Air Conditioning, Center Console, Fog Lights, Passenger Airbag, Power Steering, Power Sunroof, Rear Spoiler, Tachometer, Tilt Wheel, Traction Control, AM Audio System, FM Audio System, Audio System with Compact Disc Player, Automatic Transmission, Manual Transmission, Cloth Trim Type, and Engine of a pre-specified type.

7. The method as claimed in claim 5, wherein each of said at least one specific parameter is selected from the group consisting of: the used vehicle has been completely repainted, the used vehicle has been a police car, the used vehicle has been a taxi, the used vehicle has been a rental car, the used vehicle is a stolen recovery, the used vehicle is an insurance write-off, the used vehicle is of a pre-specified interior colour, and the used-vehicle is of a pre-specified exterior colour.

8. The method as claimed in claim 5, wherein each of said at least one mechanical component is selected from the group consisting of: alignment, front brakes, rear brakes, control arm brushings, exhaust complete, exhaust tailpipe, front tires, rear tires, tune-up, air conditioning, head gasket, headlights, indicators, front shocks, rear shocks, steering, power antenna, power locks, power mirrors, power seat driver, power seat passenger, and power windows.

9. The method as claimed in claim 5, wherein each of said at least one specific visual aspect is selected from the group consisting of: worn carpets, dents, rusts, and stone chips.

10. The method as claimed in claim 5, wherein said at least one pre-specified factor is at least one of a maximum cash value for mechanical reconditiong and a maximum cash value for visual reconditioning.

11. The method as claimed in claim 1, wherein the input data associated with at least one appraisal profile of said plurality of appraisal profiles further comprises one or more flags, wherein if at least one of said one or more flags is set, then a guaranteed price will not be calculated for a seller-identified used vehicle to which said one or more flags apply using the input data associated with said at least one appraisal profile.

12. A system for facilitating the real-time pricing, sale, and appraisal of a used vehicle, the system comprising:
a) a system database comprising data received from a first plurality of buyers, said data associated with a plurality of appraisal profiles, wherein the data associated with an appraisal profile comprises check writing prices for a plurality of used vehicle models, wherein each check writing price represents a price offered by a buyer to purchase a used vehicle of a used vehicle model to which a plurality of base conditions apply;
b) a user interface for providing output to a seller and receiving details associated with a specific seller-identified used vehicle, wherein the model and actual condition of said seller-identified used vehicle are described; and
c) at least one module connected to said database and said user interface, said at least one module programmed to generate at least one guaranteed price for said seller-identified used vehicle in response to a request of said seller, and for providing said at least one guaranteed price for output to said seller through said user interface;
wherein in generating said at least one guaranteed price for said seller-identified used vehicle, price adjustments are made to check writing prices for a used vehicle model of the same model as said seller-identified used vehicle, wherein said price adjustments account for differences between the actual condition of said seller-identified used vehicle as described by the seller and the base conditions that apply to said used vehicle model.

13. The system as claimed in claim 12 further comprising a messaging module for connection to a network, wherein said messaging module is programmed to send a price request to each of a second plurality of buyers for a guaranteed price for said seller-identified used vehicle, and to receive price requests from said second plurality of buyers.

14. The system as claimed in claim 13, wherein said network is a wireless network.
